(19) United States
(12) Patent Application Publication
(10) Pub. No.: US 2025/0067522 A1
(43) Pub. Date: Feb. 27, 2025

(54) PCM Cell and System Technology

(71) Applicant: Michaels Energy, Inc., Lacrosse, WI (US)

(72) Inventors: Stan NABOZNY, The Woodlands, TX (US); Vaughn ENGLER, Boulder, CO (US); Johathan KENDRICK, Henrico, VA (US); Rob PARKER, La Crosse, WI (US); Andrew CLEMENCE, Boulder, CO (US)

(73) Assignee: Michaels Energy, Inc., Lacrosse, WI (US)

(21) Appl. No.: 18/811,752

(22) Filed: Aug. 21, 2024

Related U.S. Application Data
(60) Provisional application No. 63/520,854, filed on Aug. 21, 2023.

(51) Int. Cl. F28D 20/02; F28D 20/00

(52) U.S. Cl. CPC F28D 20/02; F28D 2020/0004

(57) ABSTRACT

A cooling system is disclosed. The cooling systems are embodied in racks, shelves, pallets, and ceiling/wall units. The cooling systems include a cooling array or group of individual cooling cells. The cooling cells utilize a Phase Change Material (PCM) for cooling.

A portion of the disclosure of this patent document may contain material which is subject to copyright protection, or which has become trade dress. The copyright and trade dress owner has no objection to the facsimile reproduction by anyone of the patent document or the patent disclosure, as it appears in the US Patent and Trademark Office patent file or records, but otherwise reserves all copyright and trade dress rights whatsoever.

### CROSS-REFERENCE TO RELATED APPLICATIONS, IF ANY

This application claims the benefit under 35 U.S.C. § 119 (e) of co-pending U.S. Provisional Patent Application Ser. No. 63/520,854, filed Aug. 21, 2024, which is hereby incorporated by reference.

If an Application Data Sheet(s) (ADS) has been filed in this application, it is incorporated by reference herein. Any applications claimed in an ADS for priority under 35 USC 119, 120, 121 or 365, and any and all parent, grandparent, great-grandparent, etc. applications of such applications, are also incorporated by reference, including any priority claims made in those applications and any material incorporated by reference, to the extent such subject matter is not inconsistent herewith.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates, generally, to heating and cooling systems, apparatus and methods. Particularly, the invention relates to cooling systems. Most particularly, the invention relates to Cooling Systems, Device, Arrays, and Cells utilizing a Phase Change Material (PCM).

### 2. Background Information

Existing technology in this field is believed to have significant limitations and shortcomings. For this and other reasons, a need exists for the present invention.

A phase-change material (PCM) is a substance which absorbs or releases energy at phase transition to provide cooling or heating. In general, the transition will be from solid and liquid, to the other. Examples of PCMs include polyethylene glycol (PEG), polyalcohols, polyethylene, and fatty acids.

All US patents and Patent Applications, and all other published documents mentioned anywhere in this application are incorporated by reference in their entirety.

### BRIEF SUMMARY OF THE INVENTION

The invention provides a Phase Change Material (PCM) cell apparatus, method, method of manufacture and method of use which are practical, reliable, accurate and efficient, and which are believed to fulfill a need and to constitute an improvement over the background technology.

In one aspect, the invention provides a cooling cell, comprising
a body having a central cavity, the body having generally rectangular configuration with a predetermined length, width and thickness, the body having opposing substantially flat surfaces and a peripheral edge defining four corners which are radiused;
an aperture disposed through the body which is sealed from the central cavity, the aperture adapted to receive an external mount for coupling the cooling cell to one or more separate cooling cells;
at least two spacers disposed on each flat surface of the body, the spacers extending from a flat surface of the body a predetermined distance, the spacers being adapted to separate the flat surfaces of the body from flat surfaces of adjacent separate cooling cells; and
a phase change material disposed in the central cavity of the body.

In another aspect, the invention provides a cooling system, comprising
a. a plurality of cooling cells, each cooling cell comprising
   i. a body having a central cavity, the body having generally rectangular configuration with a predetermined length, width and thickness, the body having opposing substantially flat surfaces and a peripheral edge defining four corners which are radiused;
   ii. an aperture disposed through the body which is sealed from the central cavity, the aperture adapted to receive an external mount for coupling the cooling cell to one or more separate cooling cells;
   iii. at least two spacers disposed on each flat surface of the body, the spacers extending from a flat surface of the body a predetermined distance, the spacers being adapted to separate the flat surfaces of the body from flat surfaces of adjacent separate cooling cells; and
   iv. a phase change material disposed in the central cavity of the body; and
b. a mount coupling the cooling cells.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 (or FIG. 1) is a perspective view of an embodiment of a Cooling Rack System of the present invention including a Rack with plural Shelves including an embodiment of a Cooling Under rack Array, and an embodiment of a Cooling Pallet Array.

FIG. 2 is another perspective view of the Cooling Rack System.

FIG. 3 is a front elevation view of the Cooling Rack System.

FIG. 4 is a side elevation view of the Cooling Rack System.

FIG. 5 is a view of a shelf of the Cooling Rack System including plural Cooling Under rack Arrays.

FIG. 6 is a diagrammatic view of an embodiment of a Cooling Array of the present invention, the Cooling Array comprises a plurality of Cooling Cells, preferably including a Phase Change Material (PCM).

FIG. 7 is a diagrammatic view of the Cooling Array connected to base rails.

FIG. 8 is a crossectional view of the Cooling array of FIG. 7.

FIG. 9 is a perspective view of the embodiment of the Cooling Under rack Array or Sub-System shown in FIGS. 1-5.

FIGS. 10A-E provide orthographic views of an alternative embodiment of the Cooling Array or Sub-System of the present invention, including tube type cells.

FIG. 11 is an exploded view of the Cooling Array of FIGS. 10A-E.

FIG. 12 is a perspective view of an embodiment of the Cooling Pallet Array.

FIG. 13 is another perspective view of the Cooling Pallet Array.

FIG. 14 is a front elevation view of the Cooling Pallet Array.

FIG. 15 is a side elevation view of the Cooling Pallet Array.

FIG. 16 is a top view of the Cooling Pallet Array.

FIG. 17 is a perspective view of an embodiment of a Cooling Ceiling Array or System of the present invention.

FIG. 18 is an elevation view of the top of the Cooling Ceiling Array, which would face a ceiling or wall when operatively deployed.

FIG. 19 is an elevation view of the bottom of the Cooling Ceiling Array, which would be visible from the room or enclosure that it is deployed in.

FIG. 20 illustrates the Rack System including an embodiment of a Reference Module of the present invention, the front side of the module being shown.

FIG. 21 is a perspective view from the rear of the Reference Module.

FIG. 22 shows an embodiment of the Reference Module, in perspective.

FIG. 23 is a front view of the Reference Module of FIG. 20.

FIGS. 24A, B, C and D are an orthographic set of views of an embodiment of the Cooling Under rack Array.

FIG. 25 is a perspective view from the bottom of the Cooling Cell.

FIG. 26 is a top elevation view of the Cooling Cell.

FIG. 27 is front, or first side, elevation view of the Cooling Cell.

FIG. 28 is a bottom view of the Cooling Cell.

FIG. 29 is a back, or second side, elevation view of the Cooling Cell.

FIG. 30 is a left end elevation view of the Cooling Cell.

FIG. 31 is a longitudinal cross-sectional view of the Cooling Cell.

FIG. 32 is a lateral cross-sectional view of the Cooling Cell.

FIG. 33 is a further longitudinal cross-sectional view of the Cooling Cell.

FIG. 34 is a perspective view of a first alternative embodiment of the Cooling Cell of the invention, having a fill weldment at one end.

FIG. 35 is an end elevation view of the Cooling Cell showing the fill weldment.

FIG. 36 is a perspective view of a second alternative embodiment of the Cooling Cell of the invention, having a fill tube at one end.

FIG. 37 is an end elevation view of the Cooling Cell showing the fill tube.

FIG. 38 is a perspective view, from the top, of a third alternative embodiment of the Cooling Cell of the invention.

FIG. 39 is a perspective view from the bottom of the Cooling Cell.

FIG. 40 is a top view of the Cooling Cell, the bottom view being substantially a mirror image thereof.

FIG. 41 is an end elevation view of the Cooling Cell, showing the fill aperture thereof.

### DETAILED DESCRIPTION

The description that follows describes, illustrates and exemplifies embodiments of Cooling Systems comprising an Array or group of individual Cooling Cells. The Cooling Cells utilize a Phase Change Material (PCM) for cooling. The Arrays of Cells are then arranged in Racks, Shelves, Pallets, Ceilings and the like.

This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a clearer description. Additionally, the drawings set forth herein are not necessarily drawn to scale, and in some instances, proportions may have been exaggerated to more clearly depict certain features.

The thermal energy storage (TES) system of the present invention is useful in commercial, industrial, governmental, and other typically large format refrigeration systems. Examples of such existing systems include warehouses, grocery and supply stores, commercial kitchen, food processing plants, blast freezers, military installations, university and laboratory coolers, and the like. These refrigerators are large and are deployed in enclosures the size of a small room to an entire warehouse. They can also comprise a vehicle, trailer, aircraft, or vessels such as fishing trawlers. In most cases, they are based on and powered by a traditional refrigeration system comprising a compressor, evaporator, chemical refrigerant, fan(s) and duct work, and electronic sensing and control devices. Despite the long history of conventional cooling technology and their wide deployment, they do have limitations, both as to reliability and efficiency. Supplementary refrigeration and control systems are often needed to increase reliability.

The thermal energy storage (TES) system of this invention eliminates the need for supplementary control systems by integrating thermal energy storage directly into the existing refrigeration system. The TES system of the invention works by charging phase change materials (PCM) without lowering the refrigeration set point, ensuring optimal PCM charging under standard operational conditions. Firstly, the thermal energy storage system of the invention utilizes phase change materials with a high-density storage capacity, configured to minimize the number of modules required for effective thermal storage, thereby reducing installation complexity and cost. Secondly, the thermal energy storage system provides an extended storage duration of up to 10 hours with additional thermal protection features, ensuring uninterrupted refrigeration and resilience against power outages or peak energy demand periods. Thirdly, the thermal energy storage system is modular and may be implemented with customer-installable form factors, enabling easy scalability and installation by end-users without the need for specialized tools or expertise. Fourthly, the thermal energy storage system may be integrated with industrial-grade wireless monitoring equipment and tailored software, providing real-time data analysis, predictive analytics, and actionable insights into refrigeration performance and energy consumption trends. Fifthly, a thermal energy storage module of the invention may comprise self-spacing cells designed to optimize heat transfer, ensuring efficient discharge of stored thermal energy, thereby enhancing system performance and simplifying installation. Lastly, the thermal energy system of the invention may be implemented in a variety of arrangements, including a standard storage rack form factor having multiple shelving for product, a wire basket pallet form factor, and a wall and/or ceiling form factor. This permits use in a variety of existing refrigeration systems including pallet racking systems, wherein the module is engineered to be forklift-resistant, preventing accidental dislodging or damage during warehouse operations. The PCM cells in the system are modular and can be assembled into different configurations, including ceiling-mounted, pallet racking, and wire basket pallets, allowing for flexible deployment in various refrigeration scenarios. These embodiments provide and optimized thermal energy storage system, configured for multiple end uses including blast freezers, refrigerated trailers, and energy storage in refrigerated spaces, designed to minimize operator error and maximize storage density.

The thermal energy storage systems of the invention permit tailored PCM formulation, enhanced resilience, predictive maintenance, and flexible safety and durability. The PCM formulation used in the system may be specifically tailored to match the facility's set point, ensuring full PCM charging during regular refrigeration cycles without deviating from standard operational temperatures. The TES system of the invention provides backup thermal protection to maintain refrigeration during peak energy demand periods, facilitating additional energy savings between consecutive peak periods. The TES system enables predictive maintenance capabilities, utilizing historical data and machine learning algorithms to forecast potential refrigeration system issues before they occur. And, the TES modules include safety features that prevent accidental damage during installation or maintenance, specifically configured to withstand harsh industrial environments.

In summary, the advantages of the system include integrated control, extended duration, high density PCM storage, versatile, modular and customer installable form factors, advanced monitoring and analytics, optimized heat transfer, tailored PCM formulation, enhanced resilience, predictive maintenance, and increased safety and durability.

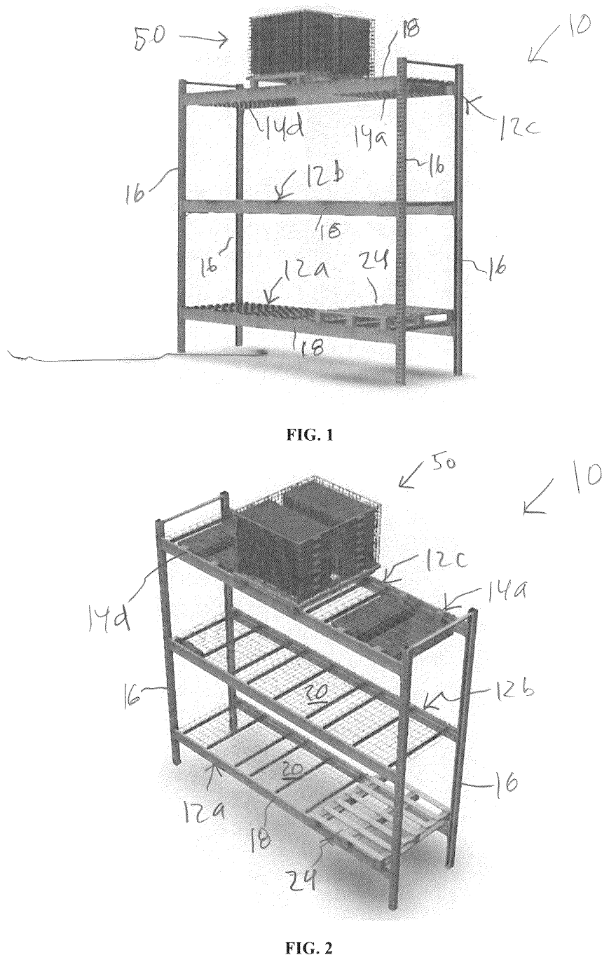

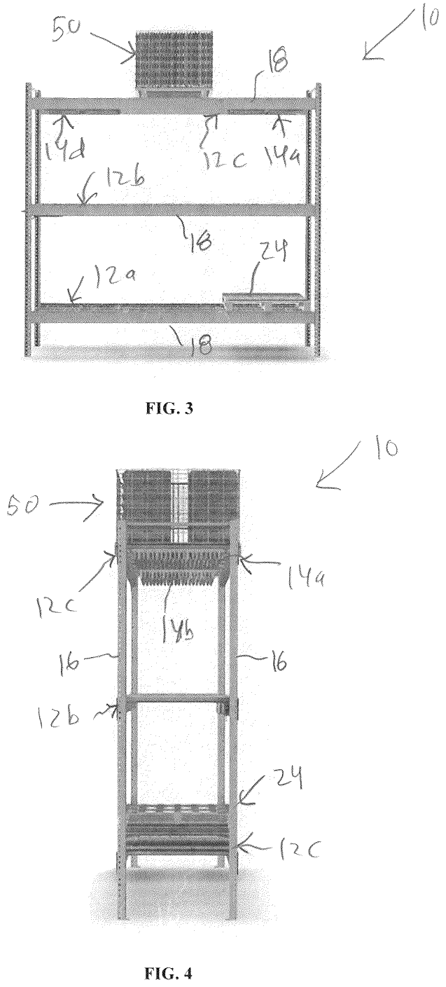

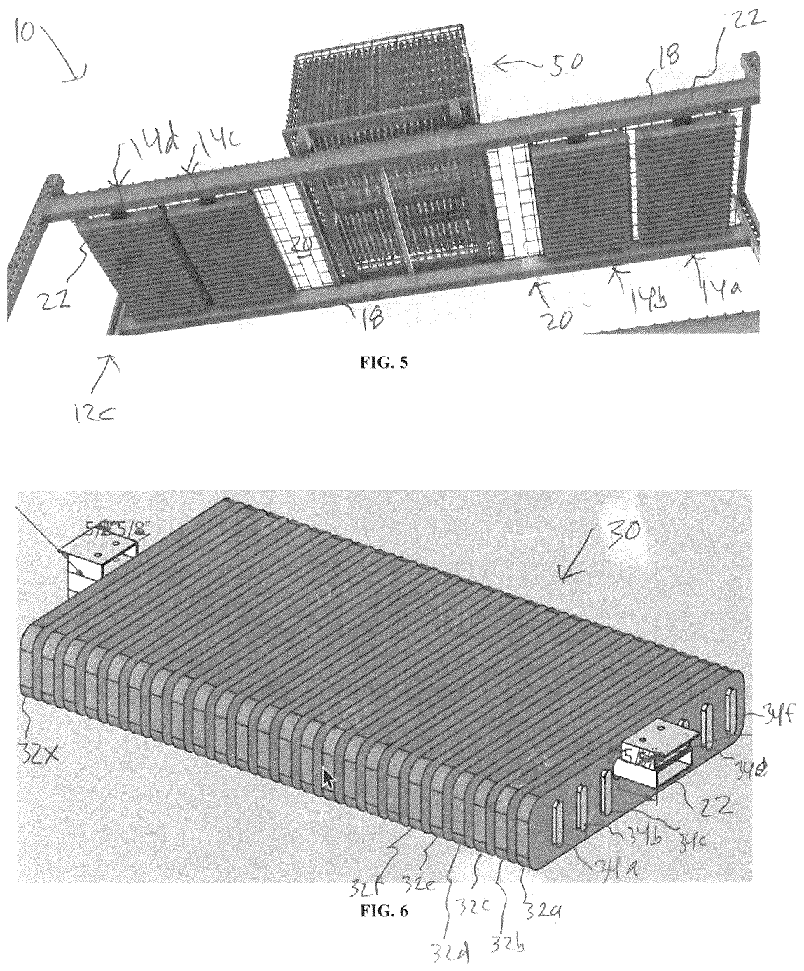

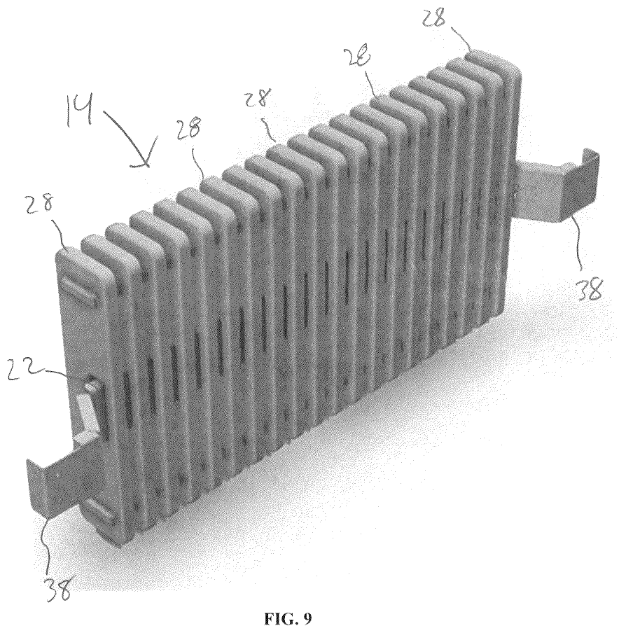

Figures (or FIGS. 1-5 and 9 show an embodiment of a Cooling Rack System 10 of the present invention including a Rack with plural Shelves 12a, 12b, and 12c supported by vertical posts 18. The shelves 12 are defined by horizontal rails 18 and planar mesh racking 20. The shelves 12 are typically between 42 and 48 inches deep. Cooling Under Rack Arrays 14a, 14b, 14c and 14d are connected to the top shelve 12c (preferably) and disposed under the mesh racking 20 thereof. FIG. 5 best shows the shelf 12c of the Cooling Rack System 10 including plural Cooling Under rack Arrays 14a, 14b, 14c, and 14d. FIG. 9 shows an array 14 consisting of twenty (20) individual PCM cells 28 connected by a central mount 22 that extends between front and back railings 18 of the rack. The cells, which are discussed in detail below, are constructed of a polymeric material, for example HDPE. The mount 22 is preferably constructed of heavy duty galvanized steel. The mount 22 has railing connectors 38 which engage the top surface of the railings 18. In the example shown, each array 14 has a low profile of approximately 6.4 inches so that it takes up minimal rack space. The total weight of each such array is approximately 48 pounds. An array 14 so constructed is expected to provide approximately 6,320 BTUs of cooling power between charges.

An example pallet 24 is shown placed on the bottom shelf 12a. The standard pallet 24 (which may be constructed of wood and of a well known design and dimensions) may hold items, articles, or material that is intended to be cooled. Further, an embodiment of a Cooling Pallet Array 50 of invention is shown optionally disposed, for further cooling power, on the top shelf 12c of the Cooling Rack System 10.

Although the Rack System 10 is shown with a particular rack, with a particular shelf 12 design and number, and with a particular number of Under Rack Arrays 14, it is within the purview of the invention that these features may be variable in design and construction, and still fulfil the function and benefits of the invention.

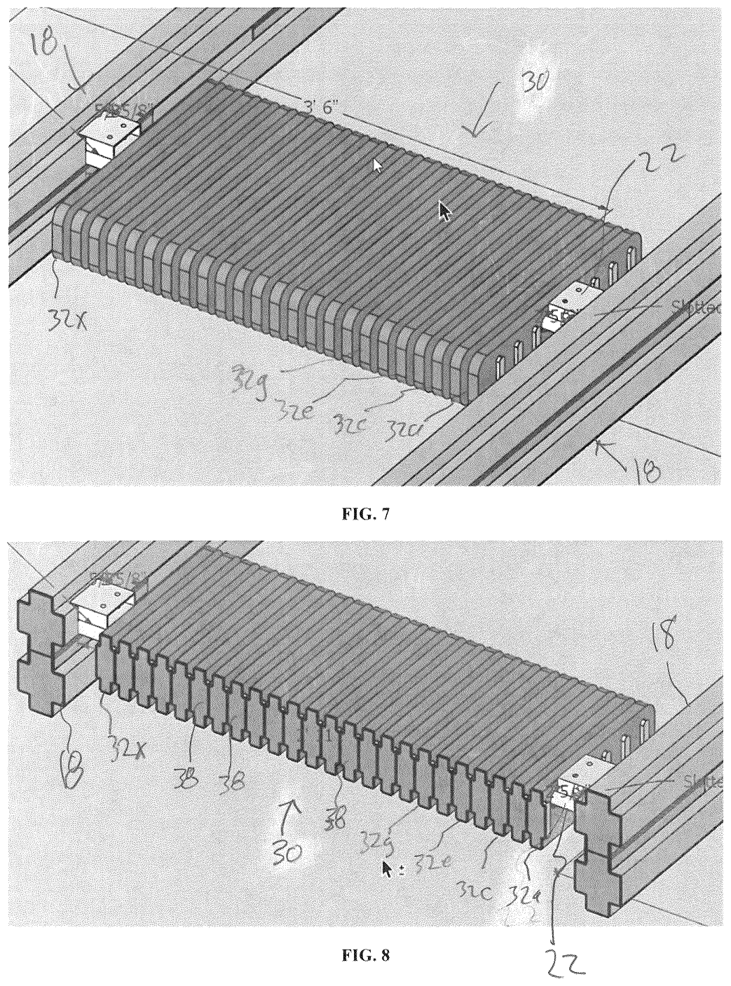

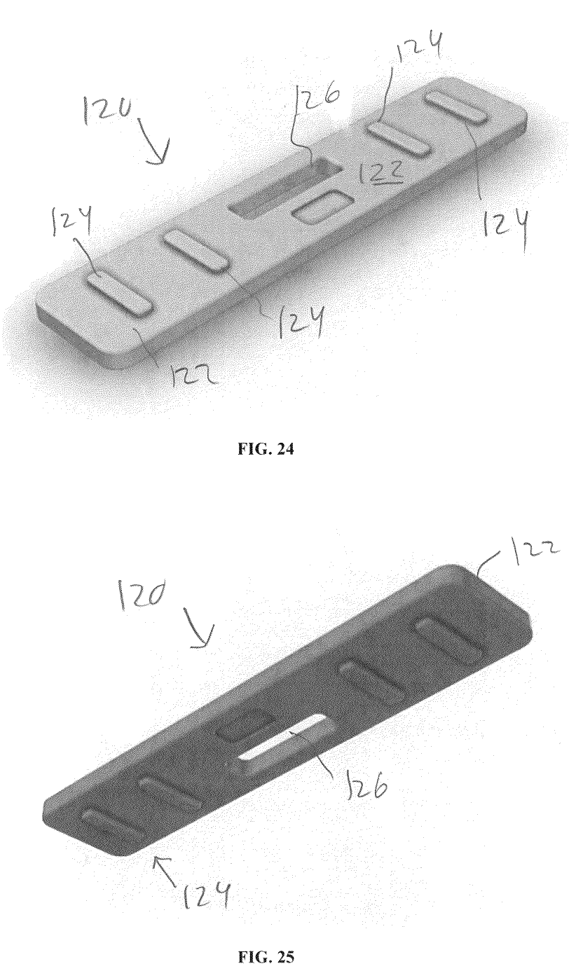

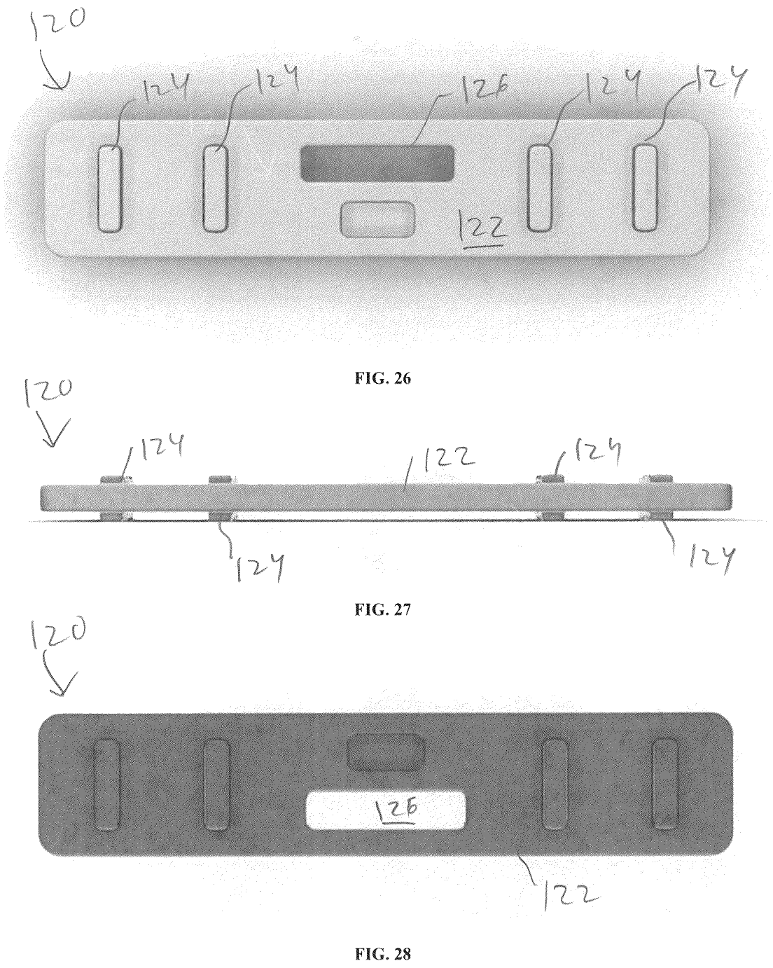

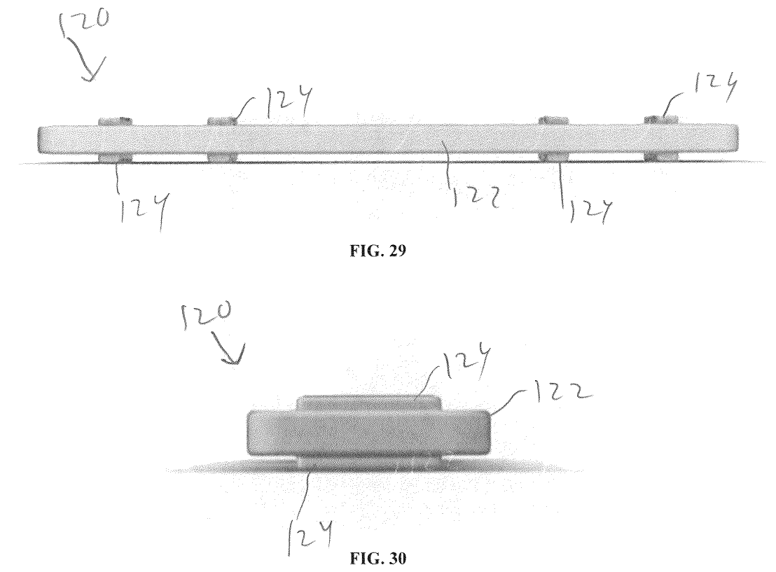

FIGS. 6-8 are diagrammatic views of a basic embodiment of a Cooling Array 30 of the present invention. Such an array 30 is utilized in the Under rack array 14 discussed in the Rack System 10 above. The Cooling Array 30 comprises a plurality of Cooling Cells 32a, 32b, 32c, 32d, 32f, 32g . . . 32x, preferably including a Phase Change Material (PCM). Referring also to FIGS. 24-30, an exemplary PCM Cell 32a has a generally rectangular configuration with radiused corners. The cell 32a has a generally flat body that consists of side, end, and top and bottom walls that define an internal cavity for containing PCM material. The body has plural extensions or outcroppings that extend outwardly a predetermined distance from each side of the body A2 and serve as spacers 34a-f to separate adjacent cells 32. The spacers 34 are aligned from side to side. The spacers 34 have a generally oval configuration with an elongated axis that is perpendicular to the long axis of the body of each cell 32. In this embodiment, the cell 32 also includes an aperture 36 that has a generally oval geometry that is elongated along an axis that is parallel (and offset (toward the top) from the center longitudinal axis) to the long axis of the body of the cell 32. The central aperture 36 permits passage of an elongated mount 22 and groups the cells together. In the Rack Cooler 10 discussed above, the mount 22 extends between rails 18 of each shelf 12. FIGS. 8, 31 and 32 are crossectional views of the PCM cells 32 (and array 30) and shows the interior cavity 38 of the cells 32 are filled with PCM material A20. In one embodiment, the body of each cell 32 is constructed of a polymeric material such as HDPE. In one embodiment, the body may be made by a molding process. The volume of each cell 32 is variable, but the example shown, it is approximately 1.0 liter. Cells are preferably filled with approximately 0.7 liters of PCM. This leaves a void which permits expansion of the phase change material during use. The cooling arrays 30 and PCM cells 32 of are designed to have a life span of approximately 20 years. The

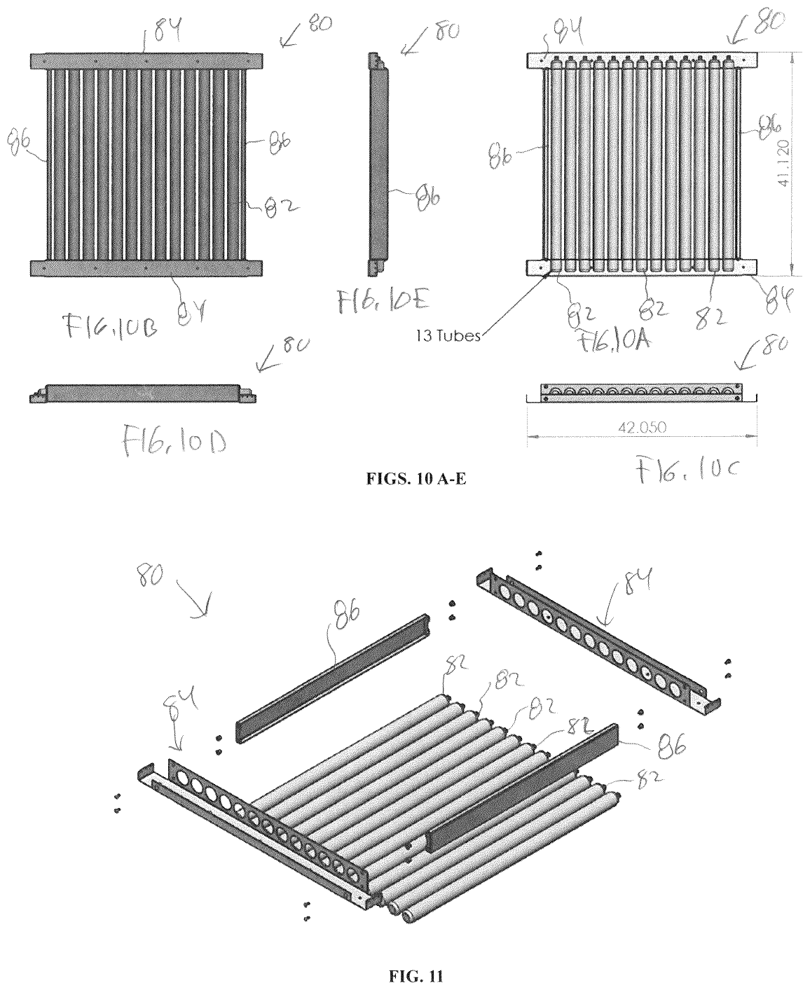

FIGS. 10A-E and-11 disclose an alternative embodiment of the Cooling Under Array 80 of the present invention. This array 80 utilizes tubular PCM cells 82, in this embodiment, thirteen (13) cells 82. The cells 82 are elongated and connected at each end by end mounts 84. Side rails 86 connect the end mounts 84

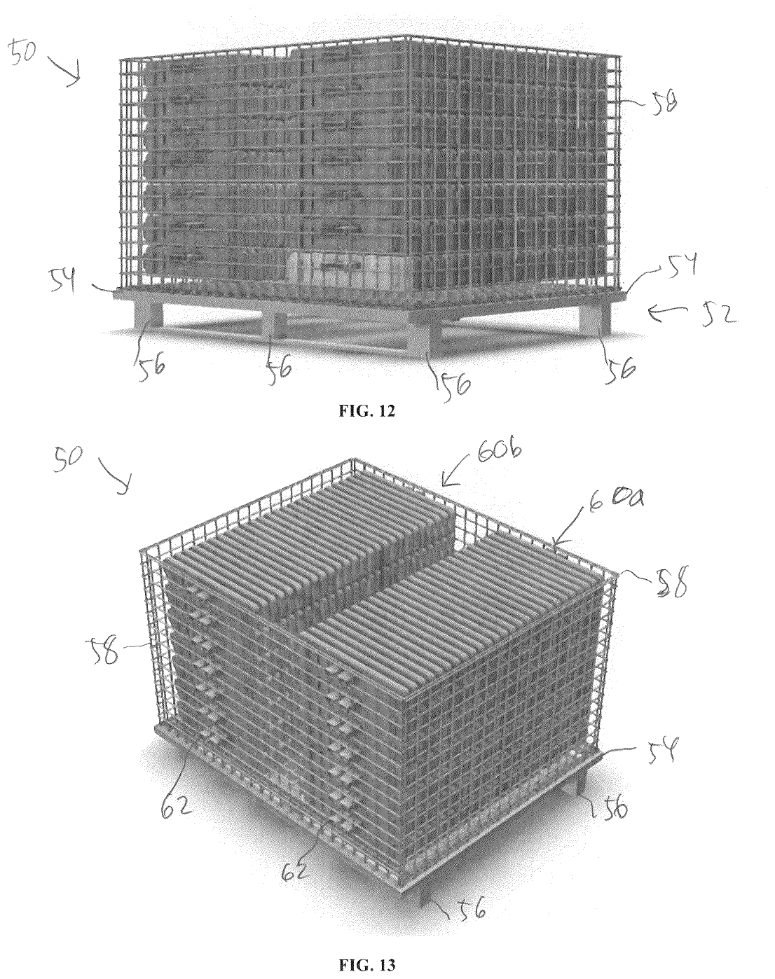

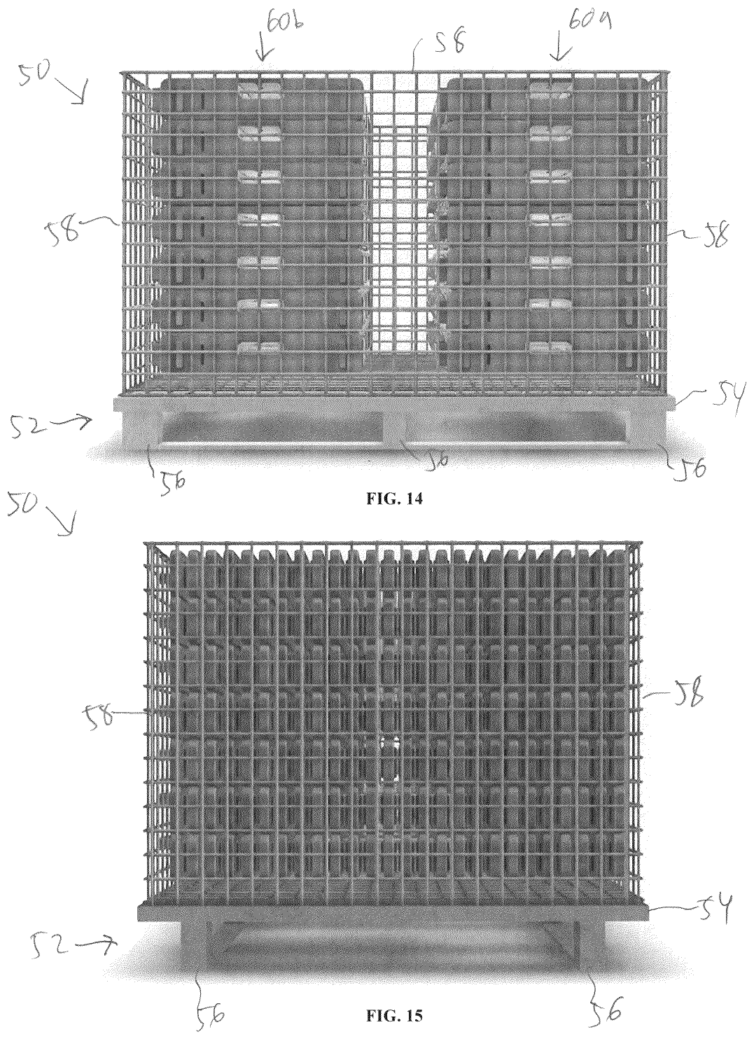

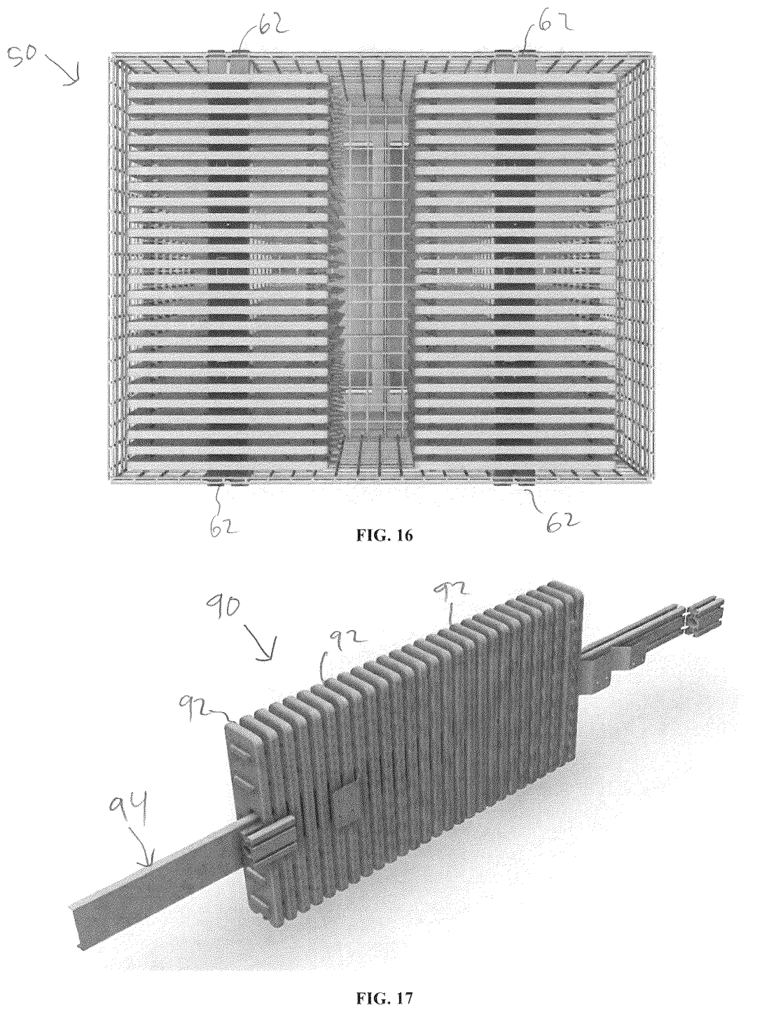

Referring to FIGS. 12-16, a preferred embodiment of the Cooling Pallet Array 50 introduced in FIGS. 1-5. The array 50 is constructed of a pallet 52 that includes a flat, planar base 54 from which legs 56 extend downwardly. The base 54 preferably has apertures for airflow. A cage 58 extends upwardly from base 54 a predetermined distance to form an enclosure that is open at the top. The cage 58 is preferably constructed galvanized steel wire. Two cell sets 60a and 60b are disposed within the cage 58, supported at their bottoms by the pallet base 54. Each cell set 60 is shown to include seven (7) layers of PCM cells. Each layer of cells is shown to consist of twenty six (26) individual, polymeric PCM cells, which are grouped by a central mount 62. The array 50 is constructed and arranged to be rackable and stackable up to four (4) arrays 50 high. In the embodiment shown, the total weight of each array 50 is approximately 915 pounds. In this arrangement, the array 50 has an anticipated cooling power of 99,500 BTUs between charges.

In one embodiment of the pallet array 50, the pallet (base and legs) is constructed of metal and is foldable. In use, the pallet is shipped to the intended deployment, unfolded, and then loaded with cells.

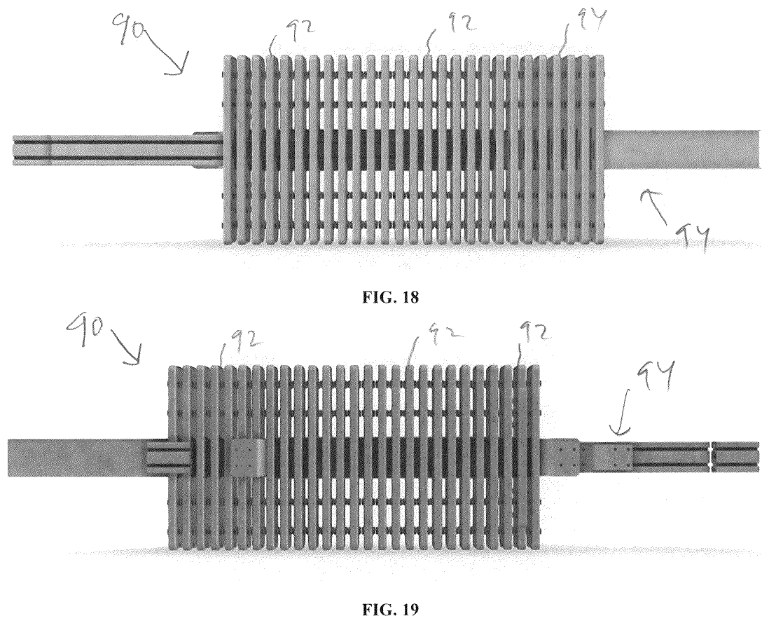

FIGS. 17-19 show an embodiment of a Cooling Array 90 which is arrangeable on a Ceiling or Wall(s) of an enclosure such as a room, compartment, vehicle trailer, or other enclosure. The array 90 is constructed and arranged in a manner similar to the Under Rack Array 14 and Basic Array 30 discussed above, and includes plural cells 92. The cells 92 are grouped by a mount 94 that is connected to a substantially flat surface such as a ceiling or wall. FIG. 18 shows the top of the Cooling Array 90, which would face a ceiling or wall when operatively deployed. FIG. 19 shows the bottom of the Cooling Array 90, which would be visible from the room or enclosure that it is deployed in. In the embodiment shown, the array 90 has a low profile of approximately 4.4 inches and low total weight of approximately 42 pounds. In this arrangement, the array 90 has an anticipated cooling power of 5,000 BTUs between charges.

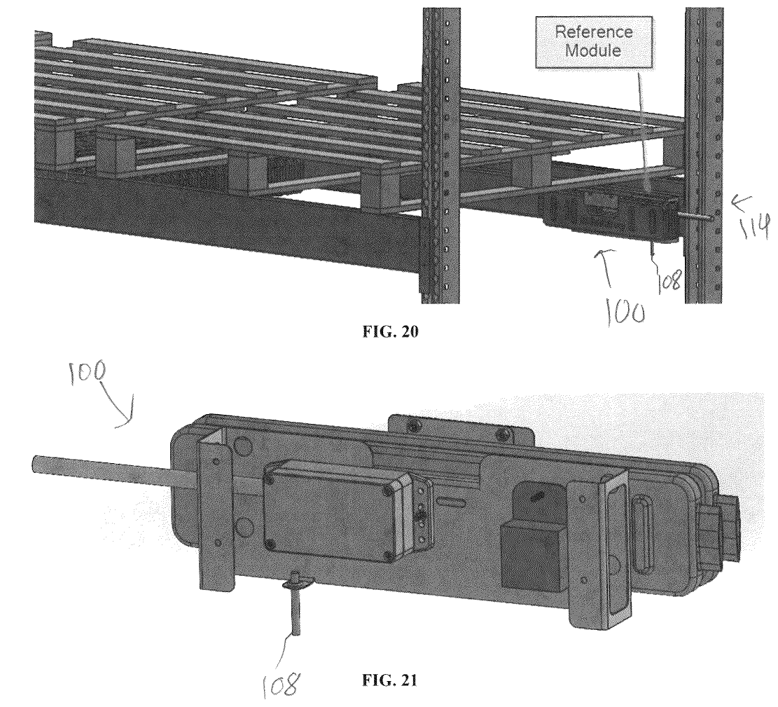

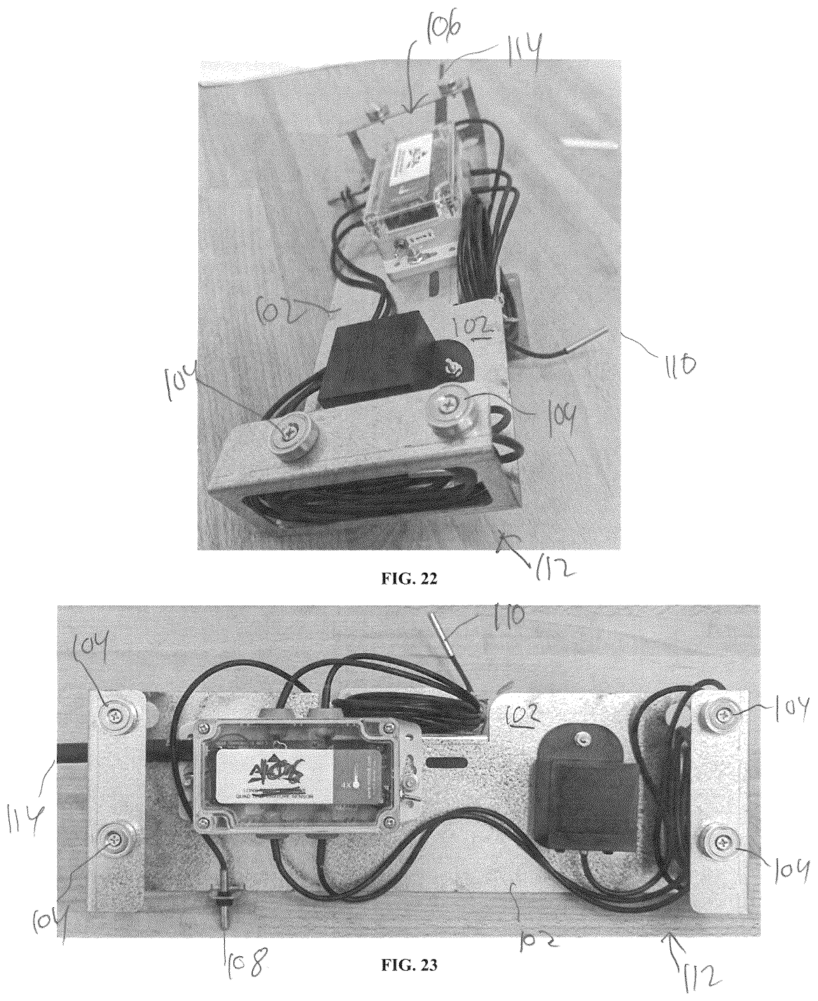

FIGS. 20-23 show the Rack System including an embodiment of a Reference Module 100 of the present invention. The module 100 permits monitoring of temperatures of the ambient air in the enclosure, the product store in the enclosure, and the PCM cell array in operation. The module 100 includes base 102, magnets 104 for mounting the base 102 to a rack, array or other structure, a sensing controller 106, a wired air temperature sensor 108, a wired product temperature sensor 110, and a wired array temperature sensor 112. The distal end of the array sensor 112 is connectable to a PCM cell as discussed further below. The sensors 108, 110 and 112 are communicatively electrically connected to the controller 106. The module 110 also has wireless communication means 114 for transmitting temperature information to a remote user. The module 100 is highly portable and configurable. Preferably, plural modules 100 are disposed in the area to be cooled to monitor plural zones in the area.

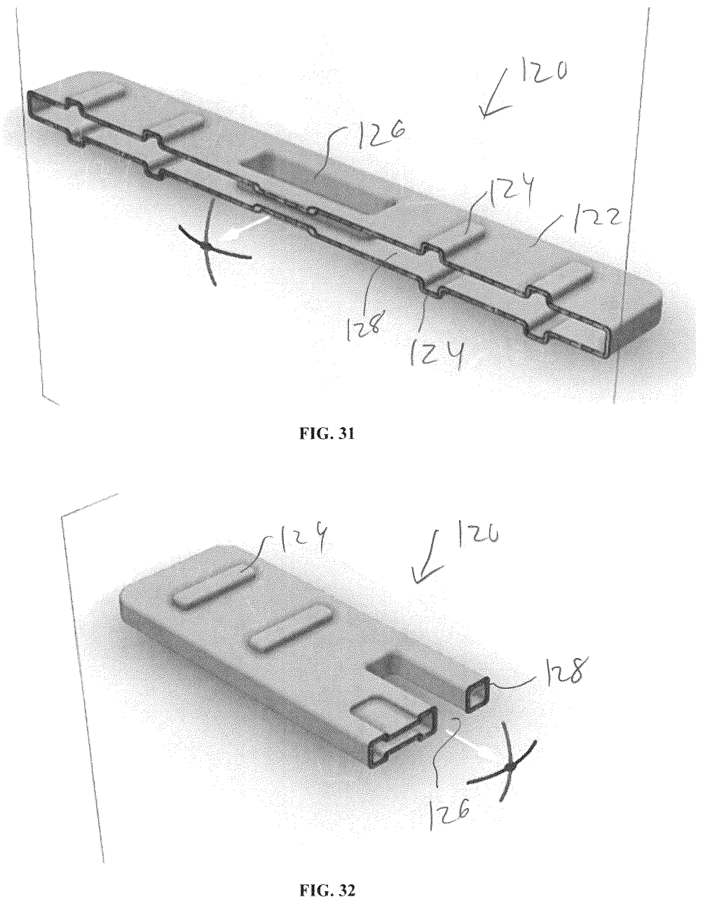

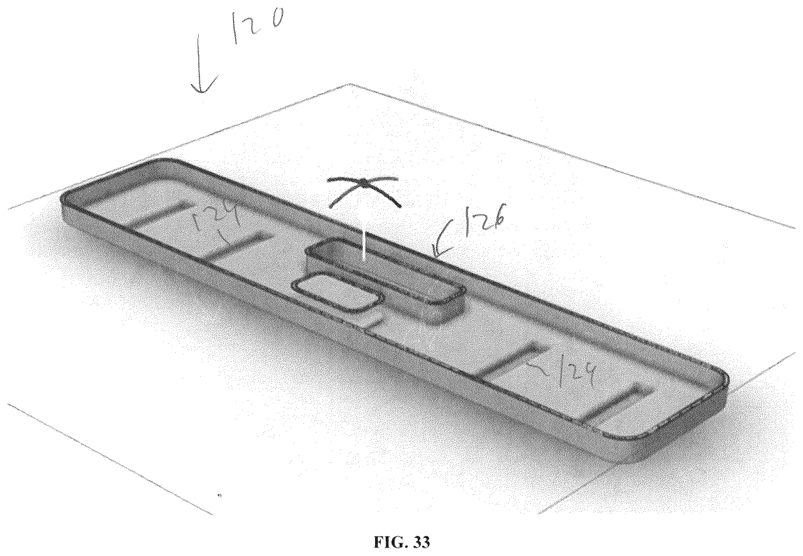

FIGS. 24-33 disclose an embodiment of an individual Cooling Cell 120, utilizing a Phase Change Material (PCM) of the present invention. The cell 120 has a generally rectangular configuration with radiused corners. The cell 120 has a generally flat body 122 that consists of side, end, and top and bottom walls that define an internal cavity for containing PCM material. The body 122 has four (4) spacers 124 that extend outwardly a predetermined distance from each side of the body 122 and serve to separate adjacent cells 120 in an array. The spacers 124 are aligned from side to side. The spacers 124 have a generally oval configuration with an elongated axis that is perpendicular to the long axis of the body 122 of each cell 120. In this embodiment, the cell 120 also includes a generally centred (longitudinally, and off centered laterally) aperture 126 that has a generally oval geometry that is elongated along an axis that is parallel (and offset (toward the top) from the center longitudinal axis) to the long axis of the body 122 of the cell 32. The central aperture 126 permits passage of, and connection to, an elongated mount (not shown) and groups the cells together. FIGS. 31-33 are crossectional views of the PCM cells 120 and the interior cavity 128 of the cells 120 are filled with PCM material such as polyethylene glycol (PEG), polyalcohols, polyethylene, or a fatty acid. The PCM may also utilize one or more salts in a solution to have multiple eutectic points whereby a change in temperature in one area (for example from 0 to −10F), one solution can hold both temperatures. Nucleating agents may also be added. In one embodiment, the body 122 of each cell 120 is constructed of a polymeric material such as HDPE. In one embodiment, the body 122 may be made by a molding process. The volume of each cell 120 is variable, but the example shown, it is approximately 1.0 liter. Cells 120 are preferably filled with approximately 0.7 liters of PCM. This leaves a void which permits expansion of the phase change material during use. The PCM cells 120 of are constructed and arrange in this fashion to have a life span of approximately 20 years.

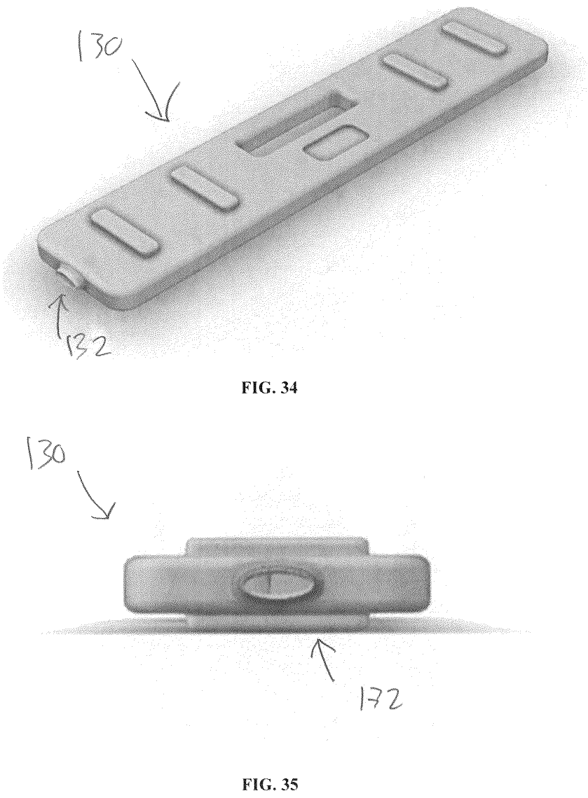

Referring to FIGS. 34 and 35, a first alternative embodiment of the Cooling Cell 130 of the invention, having a generally flat, thin fill weldment 132 at one end, is disclosed. The weldment permits filling the cell 130 after which the weldment is clamped, heated, and sealed without any other element. The cell 130 is otherwise similar to that of cell 120.

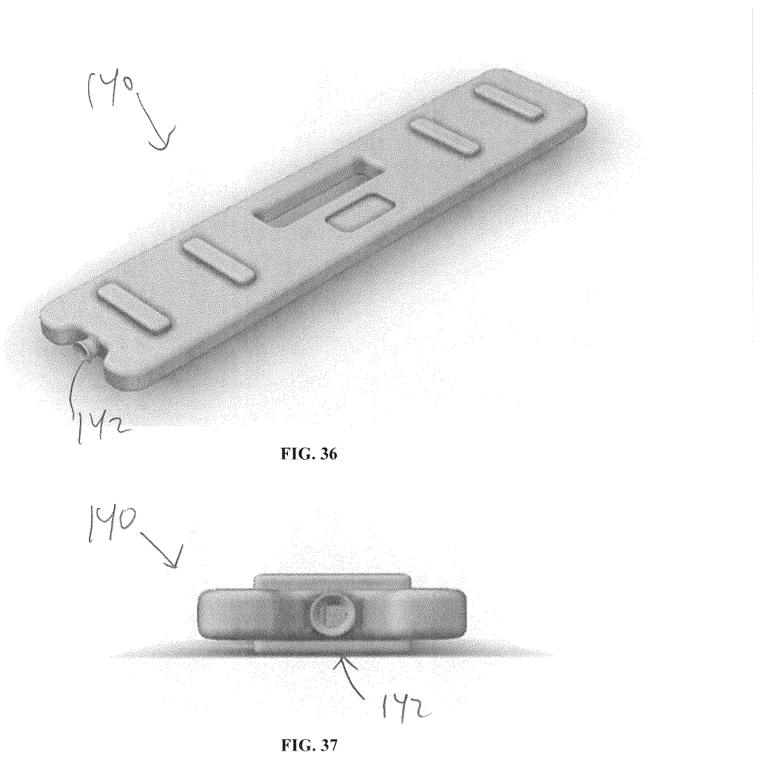

FIGS. 36 and 37 show second alternative embodiment of the Cooling Cell 140 of the invention, having a generally round fill tube 142 at one end. The tube 142 is similar to the weldment of cell 130, but requires an extra plug element to be inserted prior to sealing.

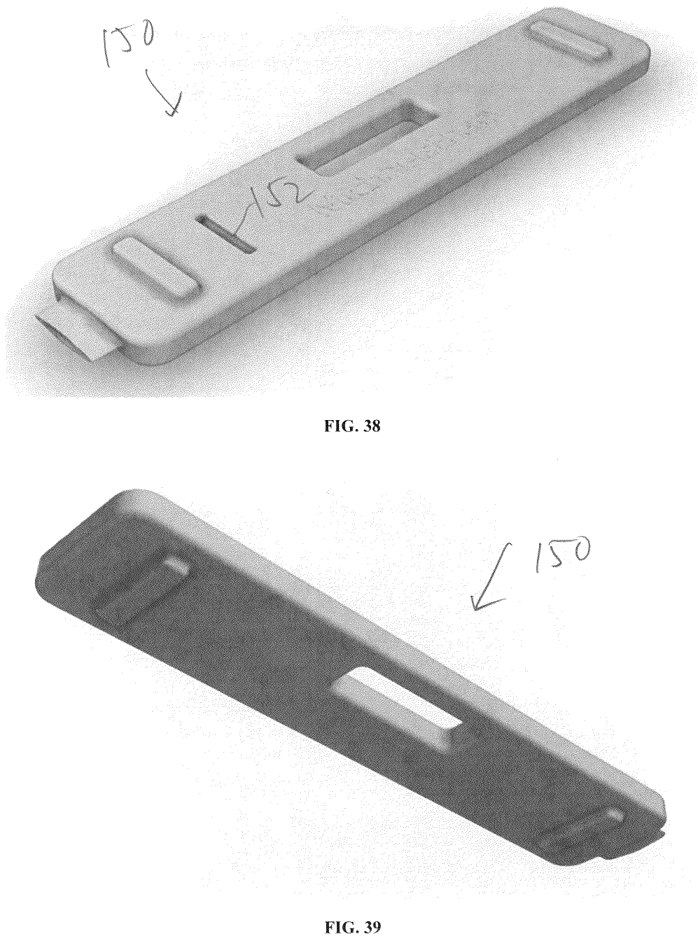

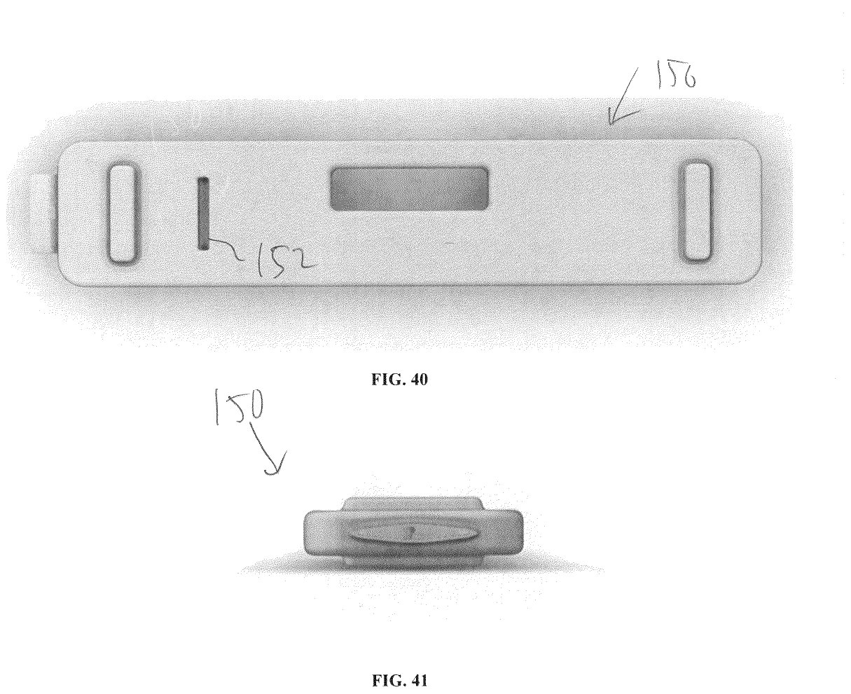

FIGS. 38-41 disclose a third alternative embodiment of the Cooling Cell 150 of the invention including a temperature sensor holding slot 152. The slot 152 engages and holds an array temperature sensor of a sensing module as is described above.

Although the apparatus, methods, methods of manufacture, and methods of use have been described in connection with the field of cool, it can readily be appreciated that it is not limited solely to such field, and can be used in other fields including, but not limited to any field utilizing PCM technology.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denotes the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. A cooling cell, comprising
a body having a central cavity, the body having generally rectangular configuration with a predetermined length, width and thickness, the body having opposing substantially flat surfaces and a peripheral edge defining four corners which are radiused;
an aperture disposed through the body which is sealed from the central cavity, the aperture adapted to receive an external mount for coupling the cooling cell to one or more separate cooling cells;
at least two spacers disposed on each flat surface of the body, the spacers extending from a flat surface of the body a predetermined distance, the spacers being adapted to separate the flat surfaces of the body from flat surfaces of adjacent separate cooling cells; and
a phase change material disposed in the central cavity of the body.

2. The cooling cell of claim 1, further comprising a fill aperture disposed on the body and providing access to the central cavity, the fill aperture being adapted to admit the phase change material to the central cavity and then be sealed.

3. The cooling cell of claim 2, wherein the body is constructed of a polymeric material that is amenable to heat sealing and wherein the fill aperture is a generally flat weldment structure disposed on a peripheral edge of the body, the weldment structure being adapted to be filled, clamped, heated, and sealed.

4. The cooling cell of claim 2, wherein the body is constructed of a polymeric material that is amenable to heat sealing and wherein the fill aperture is a generally round, tubular weldment structure disposed on a peripheral edge of the body, the weldment structure being adapted to be filled, plugged with an external stop member, heated, and sealed.

5. The cooling cell of claim 1 wherein the aperture is disposed longitudinally centrally with respect to the body and has a rectangular configuration adapted to receive and couple with a rectangular external mount.

6. The cooling call of claim 1, wherein the spacers are unitary with the body and communicatively connected to the central cavity.

7. The cooling cell of claim 1:
a. further comprising a fill aperture disposed on the body and providing access to the central cavity, the fill aperture being adapted to admit the phase change material to the central cavity and then be sealed;
b, wherein the body is constructed of a polymeric material that is amenable to heat sealing and wherein the fill aperture is a generally flat weldment structure disposed on a peripheral edge of the body, the weldment structure being adapted to be filled, clamped, heated, and sealed;
c, wherein the aperture is disposed longitudinally centrally with respect to the body and has a rectangular configuration adapted to receive and couple with a rectangular external mount; and
d, wherein the spacers are unitary with the body and communicatively connected to the central cavity.

8. A cooling system, comprising
a. a plurality of cooling cells, each cooling cell comprising
i. a body having a central cavity, the body having generally rectangular configuration with a predetermined length, width and thickness, the body having opposing substantially flat surfaces and a peripheral edge defining four corners which are radiused;
ii. an aperture disposed through the body which is sealed from the central cavity, the aperture being adapted to couple the cooling cell to one or more separate cooling cells;
iii. at least two spacers disposed on each flat surface of the body, the spacers extending from a flat surface of the body a predetermined distance, the spacers being adapted to separate the flat surfaces of the body from flat surfaces of adjacent, separate cooling cells; and
iv. a phase change material disposed in the central cavity of the body; and
b. a mount for coupling the cooling cells, the mount being disposed through the apertures of the cooling cells.

9. The cooling system of claim 8, wherein each cooling cell further comprises a fill aperture disposed on the body and providing access to the central cavity, the fill aperture being adapted to admit the phase change material to the central cavity and then be sealed.

10. The cooling system of claim 9, wherein the cooling cell body is constructed of a polymeric material that is amenable to heat sealing and wherein the fill aperture is a generally flat weldment structure disposed on a peripheral edge of the body, the weldment structure being adapted to be filled, clamped, heated, and sealed.

11. The cooling system of claim 9, wherein the cooling cell body is constructed of a polymeric material that is amenable to heat sealing and wherein the fill aperture is a generally round, tubular weldment structure disposed on a peripheral edge of the body, the weldment structure being adapted to be filled, plugged with an external stop member, heated, and sealed.

12. The cooling system of claim 8 wherein:
a. the cooling cell aperture is disposed longitudinally centrally with respect to the body;
b. wherein the cooling cell aperture has a predetermined geometric configuration; and
c. wherein the mount has a geometric configuration complementary with the geometric configuration of the cooling cell aperture, and in use, the mount is disposed through the apertures of plurar cooling cells to couple the cooling cells.

13. The cooling system of claim 12, wherein cooling cell aperture has a predetermined internal dimension and the mount has a predetermined external dimension which is less than the internal dimension of the cooling cell aperture.

14. The cooling system of claim 12, wherein the geometric configuration of the aperture of each cooling cell and the geometric configuration of the mount are rectangles.

15. The cooling system of claim 8, wherein the cooling cell spacers are unitary with the body and communicatively connected to the central cavity.

16. The cooling system of claim 8, wherein the mount is elongated and has a predetermined length, whereby the cooling cells and the mount form a cooling array or group of cooling cells.

17. The cooling system of claim 16, wherein the mount has a connector at each end, the connectors being adapted to connect the cooling array to a shelf of a rack.

18. The cooling system of claim 16, wherein the mount is adapted to connect the cooling array to a flat, external ceiling or wall surface.

19. The cooling system of claim 8, further comprising:
a. at least two groups of cooling cells, each group comprising a mount with plural cooling cells, the at least two groups of cooling cells being stacked vertically upon each other;
b. a movable pallet adapted to be disposed on a floor of a compartment of a building, a vehicle trailer, an aircraft, or a vessel, or a shelf of a rack; the pallet having:
i. a substantially flat base of a predetermined outer dimension at least large enough to hold a group of cool cells; and
ii. a cage coextensive with an outer periphery of the base and extending upwardly from the base a predetermined height, the cage having an open upper end;
iii. the cage holding the at least two stacked groups of cooling cells while permitting ingress and egress of groups of cooling cells to and from the pallet.

20. The cooling system of claim 16, further comprising at least one temperature sensing unit, the temperature sensing unit being constructed and arranged to be disposed proximate a cooling array, the temperature sensing unit having at least one temperature sensor for sensing a temperature selected from the group of temperatures consisting of ambient air temperature, cooling array temperature, and the temperature of an article or material being cooled by the cooling system.
